(19) United States
(12) Patent Application Publication
(10) Pub. No.: US 2019/0160541 A1
(43) Pub. Date: May 30, 2019

(54) METHODS AND COMPOSITIONS FOR MAKING A NEAR NET SHAPE ARTICLE

(71) Applicant: Lincoln Global, Inc., Santa Fe Springs, CA (US)

(72) Inventors: Badri K. Narayanan, Highland Heights, OH (US); Michael Andrew Kottman, Cleveland, OH (US); Vaidyanath Bharata Rajan, Mentor, OH (US)

(21) Appl. No.: 16/189,117

(22) Filed: Nov. 13, 2018

Related U.S. Application Data
(60) Provisional application No. 62/592,045, filed on Nov. 29, 2017.

(51) Int. Cl. B22F 7/00; B22F 3/105; B22F 5/00; C22C 38/44; C22C 38/46; C22C 38/58

(52) U.S. Cl. CPC B22F 7/008; B22F 3/1055; B22F 5/00; B33Y 10/00; C22C 38/46; C22C 38/58; C22C 38/44

(57) ABSTRACT

Methods and compositions for making a near net shape article are provided. The method includes depositing a first material using an additive manufacturing technique to form a near net shape article, such as tooling. The first material has a low carbon content yet possesses sufficient hardness so that the article may be used in various tooling applications.

### CROSS REFERENCE TO RELATED APPLICATIONS

This application claims priority to and the benefit of U.S. Provisional Patent Application No. 62/592,045, filed Nov. 29, 2017, the entire disclosure of which is incorporated herein by reference in full.

### FIELD

The general inventive concepts relate to methods and compositions for making a near net shape article. More particularly, the general inventive concepts relate to additive manufacturing methods for making near net shape articles using low carbon content alloy materials that possess sufficient hardness for use in various applications.

### BACKGROUND

Additive manufacturing has been utilized to manufacture functional metal parts in various fields of technology including automobiles, aerospace, and medical devices, just to name a few. Unlike conventional manufacturing processes, metal additive manufacturing techniques permit complex geometry and functional part fabrication by adding thin layers of metal based on a digital model (e.g., a CAD model) without the need for expensive tooling and assembly.

Manufacturing tooling with tool steels via additive manufacturing techniques is very difficult because of the hard and brittle nature of the additively deposited tool steel material. Indeed, tool steels typically have a carbon content of 0.5 wt % to 1.5 wt % to produce tooling that has the required hardness for a given tooling application. However, the carbon content of such tool steels is also a primary factor leading to the brittleness of the additively deposited material.

Accordingly, there remains a need for additive manufacturing methods and compositions that produce tooling that exhibits good hardness as well as toughness for various tooling applications.

### SUMMARY

The general inventive concepts relate to methods and compositions for making a near net shape article, such as tooling. To illustrate various aspects of the general inventive concepts, several exemplary embodiments of the method and composition are disclosed.

In one aspect of the present disclosure, a method of making a near net shape article is provided. The method includes depositing a first material using an additive manufacturing technique to form a near net shape article. The first material comprises at least 8 wt % Cr, and less than or equal to 0.15 wt % C. The first material is deposited via the additive manufacturing technique at a rate of at least 112 cm³/hr. The first material as deposited has a hardness (Rockwell C Scale) of 25 HRC to 50 HRC.

In another aspect of the present disclosure, a method of making a near net shape article is provided. The method includes depositing a first material using an additive manufacturing technique to form a near net shape article. The first material comprises 11 wt % to 14 wt % Cr, and 0.02 wt % to 0.15 wt % C. The first material is deposited via the additive manufacturing technique at a rate of 112 cm³/hr to 570 cm³/hr. The first material as deposited has a hardness (Rockwell C Scale) of 25 HRC to 50 HRC.

Other aspects, advantages, and features of the general inventive concepts will become apparent to those skilled in the art from the following detailed description.

### DETAILED DESCRIPTION

While the general inventive concepts are susceptible of embodiment in many different forms, there will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

The present description discloses exemplary methods and compositions for making a near net shape article. The exemplary methods and compositions of the present disclosure utilize an additive manufacturing technique that employs a first material to fabricate near net shape articles (e.g., tooling) that possess good hardness while having a low carbon content (e.g., ≤0.15 wt % C). The low carbon content of the first material makes the first material well suited for deposition via an additive manufacturing technique. However, to achieve a hardness similar to articles fabricated with conventional tool steels, which typically have a higher carbon content (e.g., 0.5 wt % to 1.5 wt % C), alloying elements including, but not limited to, Mn, Cr, Mo, Ni, Si, and B are used to provide the first material with the required carbon equivalent to attain hardness characteristics similar to conventional tool steels.

The carbon equivalent (CEN) provides a measure of the hardenability obtainable in the as-deposited material by adding alloying elements in place of carbon at a given nominal carbon content. The CEN values described in the present disclosure are derived from the formula below:

$$CEN = C + A ( C ) \times ( \frac{Si}{24} + \frac{Mn}{6} + \frac{Cu}{15} + \frac{Ni}{60} + \frac{Cr + Mo + Nb + V}{5} + 5 B )$$

where A(C)=0.75+0.25 tanh{20×(C−0.12)}. Accordingly, materials having a low carbon content (e.g., ≤0.15 wt % C), which are typically not suitable for fabricating tooling due to a lack of hardness, can be formulated to provide a hardness similar to conventional tool steels by ensuring that the CEN of the material corresponds to the carbon content present in conventional tool steels.

In one aspect of the present disclosure, a method of making a near net shape article is provided. The method includes depositing a first material using an additive manufacturing technique to form a near net shape article. The first material comprises at least 8 wt % Cr, and less than or equal to 0.15 wt % C. The first material is deposited via the additive manufacturing technique at a rate of at least 112 cm³/hr. The first material as deposited has a hardness (Rockwell C Scale) of 25 HRC to 50 HRC.

In another aspect of the present disclosure, a method of making a near net shape article is provided. The method includes depositing a first material using an additive manufacturing technique to form a near net shape article. The first material comprises 11 wt % to 14 wt % Cr, and 0.02 wt % to 0.15 wt % C. The first material is deposited via the additive manufacturing technique at a rate of 112 cm³/hr to 570 cm³/hr. The first material as deposited has a hardness (Rockwell C Scale) of 25 HRC to 50 HRC.

Generally, the near net shape article is built up layer-by-layer by depositing the first material in multiple passes performed by the additive manufacturing technique. A variety of additive manufacturing techniques may be used to deposit the first material to form the near net shape article. The additive manufacturing technique may be a powder-based technique that utilizes a powder feedstock, or a wire fed technique that utilizes a wire feedstock. Accordingly, the materials utilized in the methods of the present disclosure may be provided in powder form and/or wire form.

Exemplary powder-based additive manufacturing techniques that may be used in the methods of the present disclosure include, but are not limited to, laser metal deposition, laser engineered net shaping, electron beam melting, powder-fed directed-energy deposition, selective laser sintering, and direct metal laser sintering. Powder-based additive manufacturing techniques build up articles in a layer-by-layer manner by sintering or melting a powder material using an energy source (e.g., laser beam, electron beam). In certain powder-based additive manufacturing techniques the powder material to be sintered or melted by the energy source is supplied by a reservoir and spread evenly over a build plate using a recoater arm to maintain the powder material at a desired level and to remove excess powder material extending above the desired level. The energy source sinters or melts a cross sectional layer of the article being built under control of a scanner system (e.g., galvo scanner). After a layer is complete, the build plate is lowered, and another layer of powder is spread over the build plate and the article being built, followed by successive sintering/melting of the powder material by the energy source. The process is repeated until the article is completely built up from the sintered/melted powder material. The energy source may be controlled by a computer system including a processor and a memory. The computer system may determine a scan pattern (e.g., based on a computer aided design (CAD) model file) for each layer and control the energy source to sinter/melt the powder material according to the scan pattern.

In other powder-based additive manufacturing techniques, the article is built up in stacked layers by sintering or melting a powder material that is fed though a nozzle. In certain systems, the powder material may be fed along with a shield gas. As the powder material is fed, the powder material is sintered or melted into a melt pool by an energy source (e.g., laser beam, electron beam). The article may be built on a substrate, which can be removed after the article is built. The melt pool formed when the energy source melts and/or sinters the powder material solidifies to form at least a portion of the article. Either the powder fed additive manufacturing apparatus, the substrate, or both may be lowered and/or moved to melt the powder material on any portion of the substrate and/or on a previously solidified portion of the article until the article is completely built up from a plurality of deposited layers. The energy source may be controlled by a computer system including a processor and a memory. The computer system may determine a predetermined path for each melt pool and subsequently solidified layer to be formed (e.g., based on a computer aided design (CAD) model file), and controls the energy source to sinter/melt the powder material according to a pre-programmed path.

Exemplary wire fed additive manufacturing techniques include, but are not limited to, laser wire metal deposition, wire arc additive manufacturing, electron beam additive manufacturing, and automated welding. In general, conventional wire fed additive manufacturing apparatus can be configured to build articles in a layer-by-layer manner by feeding a wire feedstock material, which is fed by a wire feeding apparatus and melting the wire feedstock material. Prior to physically building up the article, the additive manufacturing process often begins with the creation of a computer aided design (CAD) file to represent an image or drawing of a desired article. Using a computer, information about the article image file is extracted, such as by identifying information corresponding to individual layers of the article. Thus, to derive data needed to form an article by additive manufacturing, the article is conceptually sliced into many thin layers with the contours of each layer being defined by a plurality of line segments or data points connected to form polylines. The layer data may be converted to suitable tool path data, such as data that is manipulated by, or in the form of, computer numerical control (CNC) codes, such as G-codes, M-codes, or the like. These codes may be utilized to control the wire fed additive manufacturing apparatus for building an article layer-by-layer.

In a wire fed additive manufacturing technique, the wire feedstock material used to build the article is melted using an energy source (e.g., an electron beam, a laser beam, an electrical arc). The building of the article may be performed on a build substrate. The energy source melts the wire feedstock material to form a melt pool, which solidifies to form at least a portion of the article. The wire fed additive manufacturing apparatus, the substrate, or both may be raised, lowered, or otherwise moved, while melting the wire feedstock material on any portion of the substrate, and/or on a previously solidified portion until the article is completely built up from a plurality of layers formed from the melted wire feedstock material. The energy source is typically controlled by a computer system that includes a processor and a memory. The computer system determines a predetermined path for each melt pool and subsequently solidified layer to be formed, and the energy source melts the wire feedstock material according to a pre-programmed path.

In embodiments, the additive manufacturing technique used to deposit the first material comprises a powder-based additive manufacturing technique, a wire fed additive manufacturing technique, or a combination of a powder-based additive manufacturing technique and a wire fed additive manufacturing technique. In embodiments, the additive manufacturing technique is a powder-based additive manufacturing technique and the first material is in powder form. In embodiments, the additive manufacturing technique is a wire fed additive manufacturing technique and the first material is in wire form. Any of the previously mentioned powder-based additive manufacturing techniques and/or wire fed additive manufacturing techniques may be used in the methods of the present disclosure to deposit the first material.

As mentioned above, the first material is deposited via the additive manufacturing technique at a deposition rate of at least 112 cm³/hr. In embodiments, the first material is deposited via the additive manufacturing technique at a deposition rate of 112 cm³/hr to 570 cm³/hr, including a deposition rate of 112 cm³/hr to 490 cm³/hr, 112 cm³/hr to 455 cm³/hr, 150 cm³/hr to 415 cm³/hr, 170 cm³/hr to 375 cm³/hr, 225 cm³/hr to 330 cm³/hr, and also including a deposition rate of 165 cm³/hr to 340 cm³/hr. In general, powder-based additive manufacturing techniques used to deposit metal materials have a lower deposition rate as compared to wire fed additive manufacturing techniques. However, powder-based additive manufacturing techniques are generally able to build more precise articles than wire fed additive manufacturing techniques.

In embodiments, the methods of the present disclosure may further comprise applying a subtractive manufacturing technique after depositing the first material. In embodiments, the methods of the present disclosure may further comprise applying a subtractive manufacturing technique after depositing the first material prior to completely forming the near net shape article (e.g., after one or more layers of the first material is deposited, after each layer of the first material is deposited). A variety of subtractive manufacturing techniques may be utilized in the methods of the present disclosure. Exemplary subtractive manufacturing techniques include, but are not limited to, milling, turning, and drilling. Such subtractive manufacturing techniques are well known to those skilled in the art and may be carried out using, for example, conventional CNC machining equipment. Accordingly, in embodiments of the present disclosure that include the application of a subtractive manufacturing technique, the subtractive manufacturing technique comprises milling, turning, drilling, or combinations thereof.

In embodiments, the near net shape article may be subjected to a post-fabrication thermal treatment. Such thermal treatments may include heat treatments, cooling treatments, or both heat treatments and cooling treatments. Examples of suitable thermal treatments for use in the methods of the present disclosure include, but are not limited to, annealing, quenching, tempering, and hot isostatic pressing. Accordingly, in embodiments, the methods of the present disclosure may further comprise a heat treatment, a cooling treatment, or both a heat treatment and a cooling treatment, and such heat treatment and/or cooling treatment may be performed during fabrication of the near net shape article, after the near net shape article is fabricated, and/or after the near net shape article is subjected to a subtractive manufacturing technique.

The first material of the present disclosure is an alloy material that comprises at least 8 wt % Cr, and less than or equal to 0.15 wt % C. The low carbon content of the first material promotes ease of deposition via additive manufacturing techniques and the chromium content provides hardenability. Indeed, in accordance with the present disclosure, the first material as deposited via an additive manufacturing technique has a hardness of 25 HRC to 50 HRC. In embodiments, the first material as deposited via an additive manufacturing technique has a hardness of 30 HRC to 45 HRC, including from 32 HRC to 44 HRC, from 32 HRC to 42 HRC, from 32 HRC to 40 HRC, from 32 HRC to 38 HRC, and also including from 32 HRC to 35 HRC. In embodiments, the first material as deposited via an additive manufacturing technique has a hardness of 32 HRC to 48 HRC, including from 32 HRC to 44 HRC, from 35 HRC to 44 HRC, from 38 HRC to 44 HRC, from 40 HRC to 44 HRC, and also including from 42 HRC to 44 HRC.

As discussed above, the first material of the present disclosure may be in powder form for use in a powder-based additive manufacturing technique, or in wire form for use in a wire fed additive manufacturing technique. Preferably, the first material is provided in wire form to avoid the handling systems and processes required for powder material. The first material of the present disclosure may be formulated so that the undiluted deposit produced by the first material has an as-deposited chemical composition as set forth in Table 1. As appreciated in the art, the undiluted deposit composition of the first material is the composition of the deposit produced without contamination from any other source.

TABLE 1
As-Deposited Composition of the First Material, wt. %

| Ingredient | Embodiment A | Embodiment B | Embodiment C |
|---|---|---|---|
| Carbon | 0.02-0.15 | 0.05-0.15 | 0.05-0.1 |
| Manganese | 0.5-2 | 0.75-1.95 | 0.78-1.9 |
| Silicon | 0.25-0.8 | 0.35-0.7 | 0.4-0.65 |
| Chromium | 8-14 | 11-13.25 | 11.4-13.1 |
| Nickel | 0.1-5.5 | 1.9-5.25 | 3.4-5.15 |
| Molybdenum | ≤1.5 | 0.6-1.45 | 0.65-1.45 |
| Vanadium | ≤0.4 | ≤0.35 | 0.01-0.35 |
| Tungsten | ≤0.4 | ≤0.35 | ≤0.3 |
| Iron | balance | balance | balance |

In embodiments, the first material of the present disclosure may have a carbon equivalent (CEN) of 1.4 to 2, including from 1.5 to 1.95, from 1.55 to 1.9, from 1.55 to 1.86, and also including from 1.64 to 1.8. In embodiments, the first material of the present disclosure may have a carbon equivalent (CEN) of 1.5 to 2, including from 1.55 to 1.95, from 1.58 to 1.95, from 1.64 to 1.9, and also including from 1.65 to 1.86. In embodiments, the first material may have an A(C) of 0.5 to 0.7, a CEN of 1.5 to 2.2, and a chromium content of 11 wt % to 14 wt %.

Examples of commercially available wire products suitable for use as the first material in accordance with the present disclosure are set forth in Table 2, in terms of their undiluted, as-deposited chemical compositions, as well as the as-deposited hardness (Rockwell C scale), the A(C) value, and the CEN value. The values listed in Table 2 may vary within plus or minus 10%. Each of the wire products listed in Table 2 are available from The Lincoln Electric Company (Cleveland, Ohio).

TABLE 2
Undiluted, As-Deposited Composition, wt. %

| | Lincore ® | Lincore ® | Lincore ® | Lincore ® | Lincore ® |
|---|---|---|---|---|---|
| Ingredient | 410 | 410NiMo | 424A | 423N | 414N |
| Carbon | 0.08 | 0.05 | 0.09 | 0.06 | 0.06 |
| Manganese | 0.8 | 0.8 | 0.8 | 1.88 | 1.27 |
| Silicon | 0.4 | 0.5 | 0.4 | 0.63 | 0.6 |
| Chromium | 12.5 | 13 | 13 | 11.5 | 12.5 |
| Nickel | 0.2 | 2 | 4.5 | 3.8 | 3.5 |
| Molybdenum | — | 1 | 1 | 1.4 | 0.7 |
| Vanadium | — | — | — | 0.3 | 0.02 |
| Tungsten | — | — | — | 0.3 | — |
| Iron | balance | balance | balance | balance | balance |
| Hardness | 32 | 35 | 40 | 42 | 44 |
| A(C) | 0.58 | 0.53 | 0.62 | 0.54 | 0.54 |
| CEN | 1.55 | 1.58 | 1.86 | 1.65 | 1.59 |

In embodiments, the methods of the present disclosure may further include depositing a second material onto at least a portion of the first material. In embodiments, the second material as deposited has a hardness of at least 160 HV (Vickers Hardness) at a temperature of 200° C. to 500° C. In embodiments, the second material as deposited has a hardness of 160 HV to 675 HV at a temperature of 200° C. to 500° C., including a hardness of 175 HV to 675 HV at a temperature of 200° C. to 500° C., a hardness of 200 HV to 675 HV at a temperature of 200° C. to 500° C., a hardness of 225 HV to 650 HV at a temperature of 200° C. to 500° C., and also including a hardness of 250 HV to 650 HV at a temperature of 200° C. to 500° C. In embodiments, the second material as deposited has a hardness of 225 HV to 650 HV at a temperature of 300° C., including a hardness of 225 HV to 600 HV at a temperature of 300° C., a hardness of 225 HV to 575 HV at a temperature of 300° C.

A variety of techniques may be utilized to deposit the second material onto at least a portion of the first material. In embodiments, the second material may be deposited using an additive manufacturing technique. In embodiments, the additive manufacturing technique used to deposit the second material onto at least a portion of the first material comprises a powder-based additive manufacturing technique, a wire fed additive manufacturing technique, or a combination of a powder-based additive manufacturing technique and a wire fed additive manufacturing technique. Accordingly, in embodiments of the methods of the present disclosure, the second material may be a powder material or a wire material. Any of the previously mentioned powder-based additive manufacturing techniques and/or wire fed additive manufacturing techniques may be used in the methods of the present disclosure to deposit the second material onto at least a portion of the first material.

In embodiments, the second material may be deposited using a thermal spray process. Exemplary thermal spray processes suitable for use in the methods of the present disclosure include, but are not limited to, plasma spraying, detonation spraying, wire arc spraying, flame spraying, high-velocity oxygen fuel spraying, high-velocity air fuel spraying, warm spraying, and cold spraying.

In embodiments, the second material may be deposited using a diffusion bonding process. In embodiments, the second material may be deposited using a physical vapor deposition (PVD) process. In general, the second material may be deposited using any conventional overlay process, including welding.

The second material may be used, for example, to provide a hard shell or a hard edge on a portion of the near net shape article formed by deposition of the first material. Exemplary materials suitable for use as the second material include, but are not limited to, maraging steels nickel-based alloys (such as Inconel® 625 alloy), and cobalt alloys. Suitable maraging steels for use as the second material include, but are not limited to, Type 18Ni1400, Type 18Ni1700, Type 18Ni1900, and Type 18Ni2400. Suitable cobalt alloys for use as the second material include, but are not limited to, cobalt 1 alloy, cobalt 6 alloy, cobalt 12 alloy, and cobalt 21 alloy.

As mentioned above, the second material of the present disclosure may be in powder form or in wire form. Preferably, the second material is provided in wire form to avoid the handling systems and processes required for powder material.

In embodiments, the second material of the present disclosure may have a carbon equivalent (CEN) of 1 to 2.7, including from 1.03 to 2.65, from 1.1 to 2.65, from 1.2 to 2.55, and also including from 1.3 to 2.3. In embodiments, the second material of the present disclosure may have a carbon equivalent (CEN) of 1.8 to 2.7, including from 1.9 to 2.65, from 1.95 to 2.55, from 2 to 2.4, and also including from 2.05 to 2.15.

In embodiments, the methods of the present disclosure may further comprise applying a subtractive manufacturing technique after depositing the second material onto the first material. Any one or more of the subtractive manufacturing techniques previously discussed may be used to remove or finish a portion of the shell layer.

In embodiments, the second material may be deposited onto the first material such that a thickness of the second material is up to 2.54 cm, including from 0.039 cm to 2.54 cm, from 0.079 cm to 2.54 cm, from 0.15 cm to 2.54 cm, from 0.31 cm to 2.54 cm, from 0.63 cm to 2.54 cm, from 1.27 cm to 2.54 cm, and also including from 1.9 cm to 2.54 cm. In embodiments, the second material may be deposited onto the first material such that a thickness of the second material is 0.039 cm to 2.54 cm, from 0.039 cm to 1.9 cm, from 0.039 cm to 1.27 cm, from 0.039 cm to 0.63 cm, from 0.039 cm to 0.31 cm, from 0.039 cm to 0.15 cm, and also including from 0.039 cm to 0.079 cm.

The near net shape articles fabricated in accordance with the methods of the present disclosure may be, for example, tooling. Examples of tooling include, but are not limited to, jigs, fixtures, dies, molds, machine tools, cutting tools, and gauges. Near net shape tooling fabricated in accordance with the present disclosure may be used in hot and/or cold environments, and may be resistant to one or more of impact, wear, deformation, corrosion, thermal shock, and erosion. Exemplary applications of such tooling include, but are not limited to, stamping, forging, or casting of metals via hot or cold processes, extruding metals or plastics, and processes that involve glass fibers or carbon fibers (e.g., fiber chopping operations).

All percentages, parts, and ratios as used herein, are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The methods and compositions of the present disclosure can comprise, consist of, or consist essentially of the essential elements and limitations of the disclosure as described herein, as well as any additional or optional ingredients, components, or limitations described herein.

The compositions of the present disclosure may also be substantially free of any optional or selected essential ingredient or feature described herein, provided that the remaining composition still contains all of the required ingredients or features as described herein. In this context, and unless otherwise specified, the term “substantially free” means that the selected composition contains less than a functional amount of the optional ingredient, typically less than 0.1% by weight, and also including zero percent by weight of such optional or selected essential ingredient.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the Applicant intends to indicate “only A or B but not both,” then the term “only A or B but not both” will be employed. Thus, use of the term “or” herein is the inclusive, and not the exclusive use. In the present disclosure, the words “a” or “an” are to be taken to include both the singular and the plural. Conversely, any reference to plural items shall, where appropriate, include the singular.

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples described. Accordingly, departures may be made from such details without departing from the spirit or scope of the general inventive concepts.

The scope of the general inventive concepts presented herein are not intended to be limited to the particular exemplary embodiments shown and described herein. From the disclosure given, those skilled in the art will not only understand the general inventive concepts and their attendant advantages, but will also find apparent various changes and modifications to the methods and compositions disclosed. It is sought, therefore, to cover all such changes and modifications as fall within the spirit and scope of the general inventive concepts, as described and/or claimed herein, and any equivalents thereof.

The scope of the claims presented herein are not limited in any way by the description and exemplary embodiments of the present disclosure. In addition, the ordinary meanings of the terms used throughout the present disclosure are not limited in any way by the description and exemplary embodiments presented herein. All of the terms presented throughout the present disclosure retain all of their many potential ordinary meanings.

What is claimed is:

1. A method of making a near net shape article, the method comprising:
depositing a first material using an additive manufacturing technique to form a near net shape article,
wherein the first material comprises at least 8 wt % Cr, and less than or equal to 0.15 wt % C;
wherein the first material is deposited at a rate of at least 112 cm³/hr; and
wherein the first material as deposited has a hardness of 25 HRC to 50 HRC.

2. The method of claim 1, wherein the additive manufacturing technique is a powder-based additive manufacturing technique and the first material is in powder form.

3. The method of claim 1, wherein the additive manufacturing technique is a wire fed additive manufacturing technique and the first material is in wire form.

4. The method of claim 1, wherein the first material comprises:
0.02 wt % to 0.15 wt % C;
0.5 wt % to 2 wt % Mn;
0.25 wt % to 0.8 wt % Si;
8 wt % to 14 wt % Cr;
0.1 wt % to 5.5 wt % Ni;
≤1.5 wt % Mo;
≤0.4 wt % V;
≤0.4 wt % W;
with the balance being Fe and incidental impurities.

5. The method according to claim 1, further comprising applying a subtractive manufacturing technique after depositing the first material.

6. The method according to claim 6, wherein the subtractive manufacturing technique comprises one or more of milling, turning, and drilling.

7. The method according to claim 1, further comprising applying a post-fabrication thermal treatment to the near net shape article.

8. The method according to claim 1, wherein the first material has a carbon equivalent (CEN) of 1.4 to 2.

9. The method according to claim 1, further comprising depositing a second material onto at least a portion of the first material, wherein the second material as deposited has a hardness of at least 160 HV at a temperature of 200° C. to 500° C.

10. The method according to claim 9, wherein the second material has a hardness of 175 HV to 675 HV at a temperature of 200° C. to 500° C.

11. The method according to claim 9, wherein the second material has a hardness of 225 HV to 650 HV at a temperature of 300° C.

12. A method of making a near net shape article, the method comprising:
depositing a first material using an additive manufacturing technique to form a near net shape article,
wherein the first material comprises 11 wt % to 14 wt % Cr, and 0.02 wt % to 0.15 wt % C;
wherein the first material is deposited at a rate of 112 cm³/hr to 570 cm³/hr; and
wherein the first material as deposited has a hardness of 25 HRC to 50 HRC.

13. The method of claim 12, wherein the additive manufacturing technique is a powder-based additive manufacturing technique and the first material is in powder form.

14. The method of claim 12, wherein the additive manufacturing technique is a wire fed additive manufacturing technique and the first material is in wire form.

15. The method of claim 1, wherein the first material comprises:
0.05 wt % to 0.15 wt % C;
0.75 wt % to 1.95 wt % Mn;
0.35 wt % to 0.7 wt % Si;
11 wt % to 13.25 wt % Cr;
0.15 wt % to 4.6 wt % Ni;
≤1.45 wt % Mo;
≤0.35 wt % V;
≤0.35 wt % W;
with the balance being Fe and incidental impurities.

16. The method according to claim 12, further comprising applying a subtractive manufacturing technique after depositing the first material, wherein the subtractive manufacturing technique comprises one or more of milling, turning, and drilling.

17. The method according to claim 12, further comprising applying a post-fabrication thermal treatment to the near net shape article.

18. The method according to claim 12, further comprising depositing a second material onto at least a portion of the first material, wherein the second material as deposited has a hardness of at least 160 HV at a temperature of 200° C. to 500° C.

19. The method according to claim 18, wherein the second material has a hardness of 175 HV to 675 HV at a temperature of 200° C. to 500° C.

20. The method according to claim 18, wherein the second material has a hardness of 225 HV to 650 HV at a temperature of 300° C.
